(19) United States
(12) Patent Application Publication
(10) Pub. No.: US 2008/0054776 A1
(43) Pub. Date: Mar. 6, 2008

(54) Light source device

(75) Inventor: Shinichi Ushijima, Himeji-shi (JP)

Correspondence Address: TAKEUCHI & KUBOTERA, LLP, SUITE 202, 200 DAINGERFIELD ROAD, ALEXANDRIA, VA, 22314, US

(73) Assignee: Phoenix Electric Co., Ltd.

(21) Appl. No.: 11/882,488

(22) Filed: Aug. 2, 2007

(30) Foreign Application Priority Data
Aug. 29, 2006 (JP) JP2006-232163

(51) Int. Cl. H01J 5/16

(52) U.S. Cl. 313/113

(57) ABSTRACT

A light source device includes: a reflector having a concave reflecting surface; a lamp attached to a central portion of the reflector; and a visible-ray reflective film formed on the reflecting surface of the reflector. The visible-ray reflective film includes alternately stacked films including a first reflective film formed of ZnS and a second reflective film having a lower refractive index than that of the first reflective film. The light source device further includes an ultraviolet blocking member for blocking ultraviolet rays included in light emitted from a light-emitting portion of the lamp, and for passing visible rays included in light emitted from the light-emitting portion. The ultraviolet blocking member is disposed between the light-emitting portion of the lamp and the reflector.

### BACKGROUND OF THE INVENTION AND RELATED ART STATEMENT

The present invention relates to a light source device having a lamp attached to a central portion of a reflector having a concave reflecting surface.

In recent years, projectors have been used in various applications such as a business presentation, a home theater device, and a rear projection television set. A light source device, which is a principal part of such a projector, generally has a structure in which a lamp (discharge lamp) is attached to a reflector having a concave reflecting surface.

The reflecting surface of the reflector attached with the lamp in such a light source device is formed of a visible-ray reflective film in order to improve illuminance. Such a visible-ray reflective film comprises two types of thin films having different refractive indexes (including a low refractive index film and a high refractive index film), which are stacked alternately.

The visible-ray reflective film reflects visible rays included in light emitted from the light source efficiently, thereby improving illuminance of the light source device. Known materials forming the low refractive index film include SiO₂ and MgF₂. Known materials forming the high refractive index film include TiO₂, Ta₂O₃ and ZnS. (Refer to Japanese Patent Publication No. 2004-303468 and Japanese Patent Publication No. 2005-149968.)

Since the reflector is exposed to an elevated temperature higher than 300° C. for a long period of time due to heat generated from the lamp, it is preferable to select a high heat-resistant material as a material forming the visible-ray reflective film.

From this point of view, TiO₂ is a most preferable material of the high refractive index film. However, besides TiO₂ is an expensive material, it is necessary to provide a high degree of vacuum for deposition of TiO₂ in a preparation process of the visible-ray reflective film, thereby increasing a manufacture cost of the light source device.

In order to lower the manufacturing cost, ZnS may be used as a substitute of TiO2. It has been known that ZnS can resist an inner surface temperature of the reflector just up to about 350° C. at the highest. However, ZnS is considered to make a light source device capable of lighting at an output power as high as 200 W or more when a structure and lighting power of the light source device are carefully optimized.

When a visible-ray reflective film includes a high refractive index film formed of ZnS and a low refractive index film formed of SiO₂, it is found that ZnS tends to be deposited on a surface of the reflector during a lifetime of the lamp, thereby lowering illuminance of the lamp. Conceivably, the problem is caused by degradation of ZnS due to prolonged exposure to ultraviolet rays emitted from the lamp.

In view of such a problem associated with the conventional device, an object of the present invention is to provide a light source device capable of preventing illuminance thereof from lowering even when the light source device includes a reflector having a surface coated with a visible-ray reflective film formed of ZnS.

Further objects and advantages of the invention will be apparent from the following description of the invention.

### SUMMARY OF THE INVENTION

According to a first aspect of the present invention, a light source device comprises a reflector having a concave reflecting surface; a lamp attached to a central portion of the reflector; and a visible-ray reflective film formed on the reflecting surface of the reflector. The visible-ray reflective film comprises alternately stacked films including a first reflective film formed of ZnS and a second reflective film having a refractive index lower than that of the first reflective film. The light source device further includes an ultraviolet blocking member for blocking ultraviolet rays included in light emitted from a light-emitting portion of the lamp, and for passing visible rays included in light emitted from the light-emitting portion. The ultraviolet blocking member is disposed between the light-emitting portion of the lamp and the reflector.

In the light source device according to the first aspect of the present invention, the ultraviolet blocking member is disposed between the light-emitting portion of the lamp and the reflector. The ultraviolet blocking member is provided for blocking ultraviolet rays included in light emitted from the light-emitting portion. Accordingly, the ultraviolet rays do not reach the visible-ray reflective film. For this reason, the first reflective film formed of ZnS in the visible-ray reflective film is not deteriorated by exposure to ultraviolet rays.

According to a second aspect of the present invention, the ultraviolet blocking member includes a tubular ultraviolet blocking member surrounding the light-emitting portion, and the tubular ultraviolet blocking member is formed of an ultraviolet blocking glass. Alternatively, the ultraviolet blocking member includes a tubular ultraviolet blocking member surrounding the light-emitting portion, and the tubular ultraviolet blocking member is formed of stacked layers comprising a translucent material layer and an ultraviolet blocking material layer.

The tubular ultraviolet blocking member surrounding the light-emitting portion is capable of absorbing an impact resulting from explosion of the light-emitting portion. That is, the tubular ultraviolet blocking member functions as a shock-absorbing member upon explosion of the light-emitting portion. For this reason, the reflector is hard to break even if the reflector is formed of a borosilicate glass having a low mechanical strength.

According to a third aspect of the present invention, the ultraviolet blocking member comprises an ultraviolet blocking coating formed on an outer surface of the light-emitting portion. Alternatively, the ultraviolet blocking member comprises the light-emitting portion formed of an ultraviolet blocking glass. In the third aspect of the present invention, the light-emitting portion also has an ultraviolet blocking capability. In the third aspect of the present, the ultraviolet blocking member may be disposed between the light-emitting portion of the lamp and the reflector, as long as the ultraviolet blocking member can block ultraviolet rays included in light emitted from the light-emitting portion.

The light source device according to the present invention is capable of preventing ultraviolet rays from reaching the visible-ray reflective film, thereby preventing illuminance of the light source device from lowering, even when the visible-ray reflective film is formed of ZnS as an inexpensive material.

The foregoing and other objects, features and attendant advantages of the present invention will become more apparent from the following detailed description of the invention in conjunction with the accompanying drawings.

### BRIEF DESCRIPTION OF THE DRAWINGS

FIG. 1(A) is a sectional view showing a light source device according to a first embodiment of the present invention, and FIG. 1(B) is a side view of the light source device according to the first embodiment of the present invention;

FIG. 2 is a sectional view showing a visible-ray reflective film according to the first embodiment of the present invention; and

FIG. 3 is a sectional view showing a light source device according to a second embodiment of the present invention.

### DETAILED DESCRIPTION OF THE PREFERRED EMBODIMENTS

Hereunder, embodiments of the present invention will be described in detail with reference to the attached drawings.

### First Embodiment

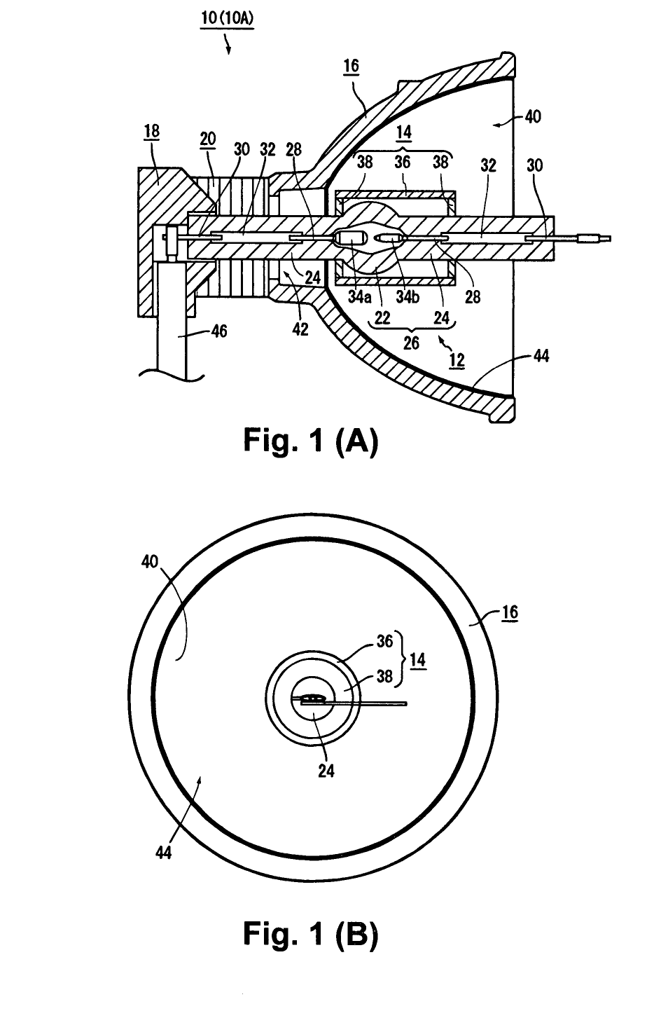

FIG. 1(A) is a sectional view showing a light source device according to a first embodiment of the present invention; and FIG. 1(B) is a side view of the light source device according to the first embodiment of the present invention. A light source device 10A (10) is adapted for use as a light source of a projector and the like. As shown in FIGS. 1(A) and 1(B), the light source 10A includes a lamp 12, an ultraviolet blocking member 14, a reflector 16, a lamp holder 18 holding the lamp 12 at an end portion thereof, and a cement 20 securing the lamp 12 and the lamp holder 18 to the reflector 16.

The lamp 12 is a direct current (DC) type short-arc high pressure discharge lamp, and is provided with an envelope 26 comprising a spherical light-emitting portion 22 and rod-shaped seal portions 24 extending straight from opposite ends of the light-emitting portion 22. Within each of the seal portions 24 of the envelope 26, there are provided an electrode pin 28 having one end protruding inside the light-emitting portion 22, a lead pin 30 having one end protruding outside the seal portion 24, and a molybdenum foil 32 electrically interconnecting the other end of the electrode pin 28 and the other end of the lead pin 30. The one ends of the electrode pins 28 protruding into the light-emitting portion 22 are attached to an anode 34a and a cathode 34b, i.e., a pair of electrodes 34, respectively. Mercury in an amount of 0.15 mg/mm³ is encapsulated within the light-emitting portion 22.

As described above, the lamp 12 shown in FIGS. 1(A) and 1(B) is the DC type high pressure discharge lamp or a double-ended type high pressure discharge lam. Alternatively, an alternate current (AC) type high pressure discharge lamp or a single-ended type high pressure discharge lamp may be used. It is also possible to use an ultra-high pressure discharge lamp.

The lamp 12 is provided with the ultraviolet blocking member 14 for passing visible rays included in light emitted from the lamp 12, and for blocking ultraviolet rays included therein to prevent ultraviolet rays from reaching the reflector 16. The ultraviolet blocking member 14 includes an ultraviolet blocking portion 36 and mounting portions 38.

The ultraviolet blocking portion 36 has a tubular shape, and is formed of an ultraviolet blocking glass for passing visible rays and blocking ultraviolet rays. The ultraviolet blocking portion 36 has an inside diameter larger than an outside diameter of the light-emitting portion 22 of the lamp 12. The ultraviolet blocking portion 36 has an axial length larger than a length of the light-emitting portion 22 along a direction that the seal portions 24 extend. One specific example of the ultraviolet blocking glass is a glass formed of SiO₂ containing a small amount of zinc oxide power or titanium oxide power.

Preferably, the ultraviolet screen 36 has a wall thickness ranging from 1.0 mm to 1.5 mm. When the wall thickness of the ultraviolet screen 36 is smaller than 1.0 mm, the ultraviolet screen 36 has an insufficient mechanical strength, thereby making it difficult to absorb an impact resulting from explosion of the lamp 12. When the wall thickness of the ultraviolet screen 36 is larger than 1.5 mm, the ultraviolet screen 36 can absorb an impact resulting from explosion of the lamp, but tends to accumulate heat generated from the lamp 12 therein. Such accumulated heat might cause explosion of the lamp 12.

The mounting portions 38 are ring-shaped members for mounting the ultraviolet screen 36 on the lamp 12. An outside diameter of the mounting portions 38 is substantially equal to an inside diameter of the ultraviolet screen 36. The mounting portions 38 have holes at center portions thereof having an inner shape fitted to an outer shape of the seal portion 24 of the lamp 12.

Preferably, the-mounting portions 38 are formed of a ceramic material having both a high thermal conductivity and high heat resistance (alumina or steatite and the like). In the embodiment, the mounting portions 38 are formed of alumina.

The reflector 16 is a bowl-shaped member for forwardly reflecting light produced by the light-emitting portion 22 of the lamp 12. The reflector 16 has an internal surface forming a concave reflecting surface 40. The reflector 16 is provided with a lamp mounting hole 42 at a center portion thereof.

The reflector 16 may be formed of various materials including glass, metal, and the like. In the embodiment, the reflector 16 is formed of a borosilicate glass as an inexpensive material. It should be noted that the borosilicate glass fractures due to a thermal stress when a temperature difference between an inner surface and an outer surface of the reflector 16 becomes larger than 180° C. Accordingly, the reflector 16 preferably has a thickness of larger than 1.8 mm and smaller than 3.5 mm, so that the temperature difference is maintained less than 180° C., thereby maintaining a sufficient substrate strength.

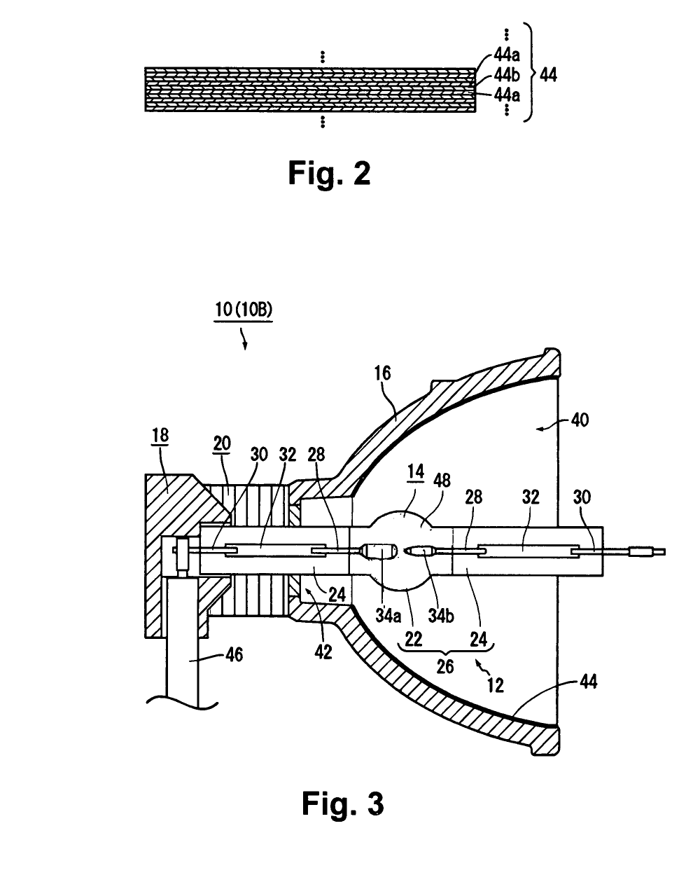

The reflecting surface 40 of the reflector 16 is coated with a visible-ray reflective film 44 for efficiently reflecting visible rays emitted from the lamp 12 forwardly. As shown in FIG. 2, the visible-ray reflective film 44 is formed by alternately stacking a first reflective film 44a formed of ZnS and a second reflective film 44b having a refractive index lower than that of the first reflective film 44a.

The visible-ray reflective film 44, as a whole, is formed of 38 to 46 layers. In the present embodiment, the visible-ray reflective film 44, as a whole, has 42 layers. The lowermost and uppermost layers of the visible-ray reflective film 44 are the second reflective films 44b.

The second reflective film 44b is formed of a material having a refractive index lower than that of the first reflective film 44a formed of ZnS. For example, the material of the second reflective film 44b includes SiO₂, MgF₂, CaF₂, NaF and the like. In the embodiment, the second reflection film 44b is formed of SiO₂.

The lamp holder 18 holds an end portion of one of the seal portions 24 of the lamp 12 as well as a power feed line 46 (see FIG. 1(A)). The lamp holder 18 is molded in an integrated component formed of a heat-resistant material such as a ceramic material.

In assembling the light source device 10, first, the mounting portions 38 are attached to the seal portions 24 located on opposite sides of the lamp 12, respectively. In the present embodiment, the mounting portions 38 are attached to the seal portions 24 at boundary portions thereof between the seal portions 24 and the light-emitting portion 22. The mounting portions 38 are disposed apart from each other according to the length of the ultraviolet screen 36 in the axial direction thereof.

After the seal portions 24 and the mounting portions 38 are cemented together, the ultraviolet blocking portion 36 is mounted on the mounting portions 38 integrated with the lamp 12, so that the mounting portions 38 and the ultraviolet blocking portion 36 are cemented together. Thus, the light-emitting portion 22 of the lamp 12 is surrounded with the ultraviolet blocking member 14 (ultraviolet blocking portion 36).

After the lamp 12 is integrated with the ultraviolet blocking member 14, one of the seal portions 24 of the lamp 12 is inserted into the lamp mounting hole 42 of the reflector 16 from a side of the reflecting surface 40. Afterward, the lamp holder 18 is fitted to an end of the one of the seal portions 24, and the lamp 12 is connected to the lamp holder 18 with cement.

Afterward, the lamp 12 is placed at the center portion of the reflector 16, and the lamp holder 18 and the one of the seal portions 24 are attached to the reflector 16 with the cement 20. The cement 20 may include alumina-silica (Al₂O₃—SiO₂) cement, alumina (Al₂O₃) cement, and silicon carbide (SiC) cement.

After the light source device 10 fitted in a projector, when the projector is powered on, an ignition voltage is applied to the lamp 12 in order to emit light from the light-emitting portion 22.

As described above, the light-emitting portion 22 is surrounded with the ultraviolet blocking portion 36. Accordingly, ultraviolet rays included in light from the light-emitting portion 22 are blocked with the ultraviolet blocking portion 36, and only visible rays pass through the ultraviolet blocking portion 36.

Accordingly, ultraviolet rays do not reach the visible-ray reflective film 44 (more specifically, the first reflective film 44a formed of ZnS in the visible-ray reflective film 44) formed on the reflecting surface 40 of the reflector 16. Therefore, the first reflective film 44a formed of ZnS is not exposed to ultraviolet, thereby preventing deterioration thereof. As a result, illuminace of the light source device 10 does not lower due to deterioration of the visible-ray reflecting film 44.

In Japanese Patent Publication No. 11-25709, an ultraviolet removing member is provided for preventing ultraviolet rays from leaking outside from a lighting device. According to Japanese Patent Publication No. 11-25709, the ultraviolet removing member may be provided on a front illuminating lens, as far as the ultraviolet removing member can prevent ultraviolet rays from leaking outside. In this case, ultraviolet rays may reach a visible-ray reflective film of a reflector, thereby lowering illuminance of the lighting device. On the other hand, in the embodiment of the present invention, the ultraviolet blocking member 14 is provided for blocking ultraviolet rays from the visible-ray reflective film 44. Accordingly, the ultraviolet blocking member 14 is not the same as the ultraviolet removing member disclosed in Japanese Patent Publication No. 11-25709.

In the present embodiment, the ultraviolet blocking portion 36 with a tubular shape is disposed so as to surround the light-emitting portion 22. For this reason, when inadvertent explosion of the lamp 12 occurs, the ultraviolet screen 36 is capable of absorbing an impact resulting from the explosion of the light-emitting portion 22. That is, the ultraviolet blocking portion 36 functions as a shock-absorbing member upon explosion of the lamp 12. For this reason, even when the reflector 16 is formed of a borosilicate glass having a low mechanical strength, the reflector 16 is hard to break.

As described above, in the embodiment, the ultraviolet blocking portion 36 is the tubular member formed of an ultraviolet screening glass. Alternatively, the ultraviolet blocking portion 36 may be formed of stacked layers of a translucent material layer and an ultraviolet screening material layer. For example, as the ultraviolet blocking member 36, an ultraviolet blocking film may be coated on a surface of a tubular member formed of a regular glass, i.e., a transparent material. In this case, the coating may be formed on an outer peripheral surface or an inner peripheral surface of the tubular member. The ultraviolet blocking film may be formed of fine power of ZnO or Al₂O₃ coated with an amorphous silica.

As described above, the tubular member may be coated with the ultraviolet blocking film on the inner peripheral surface or the outer peripheral surface thereof. Preferably, the coating is formed on the outer peripheral surface of the tubular member, thereby preventing heat from accumulating within the tubular member, and preventing the lamp 12 from easily braking.

When the tubular ultraviolet blocking portion 36 surrounds the light-emitting portion 22, heat generated by the lamp 12 may accumulate within the ultraviolet blocking portion 36, thereby excessively heating and causing explosion of the lamp 12. In order to prevent heat from accumulating within the ultraviolet screen 36, the mounting portions 38 may be provided with a vent hole. Alternatively, just one of the mounting portions 38 may be provided.

### Second Embodiment

A second embodiment of the present invention will be explained next. FIG. 3 is a sectional view showing a light source device 10B (10) according to the second embodiment of the present invention. In the light source device 10B, the ultraviolet blocking member 14 is formed of an ultraviolet blocking coating 48 formed on the light-emitting portion 22 of the lamp 12. The ultraviolet blocking coating 48 may be formed of fine power formed of ZnO or Al₂O₃ coated with an amorphous silica. Components in the second embodiment similar to the components in the first embodiment shown in FIGS. 1(A), 1(B) and 2 are designated with the same reference numerals, and explanations thereof are omitted.

In the present embodiment, the light-emitting portion 22 is coated with the ultraviolet blocking coating 48. Alternatively, the envelope 26 including the seal portions 24 may be coated with the ultraviolet blocking coating 48. It is suffice that the ultraviolet blocking coating 48 is formed on at least the light-emitting portion 22 for obtaining the effect of the ultraviolet blocking member 14.

Similar to the first embodiment, in the second embodiment, it is possible to prevent the first reflective film 44a formed of ZnS from deteriorating due to exposure to ultraviolet rays, whereby preventing illuminance of the light source device 10 from lowering.

Though not shown, the envelope 26 of the lamp 12 may be formed of an ultraviolet blocking glass. In the case, the envelope 26 itself functions as the ultraviolet blocking member 14, thereby preventing the first reflective film 44a formed of ZnS from deteriorating due to ultraviolet rays, and preventing illuminance of the light source device 10 from lowering, i.e., obtaining an effect same as that in the second embodiment.

The disclosure of Japanese Patent Application No. 2006-232163, filed on Aug. 29, 2006, is incorporated herein by reference in its entirety.

While the invention has been explained with reference to the specific embodiments of the invention, the explanation is illustrative and the invention is limited only by the appended claims.

What is claimed is:

1. A light source device comprising:
a reflector having a concave reflecting surface;
a lamp attached to a central portion of the reflector; a visible-ray reflective film formed over the reflecting surface of the reflector, said visible-ray reflective film being formed of alternately stacked films including a first reflective film formed of ZnS and a second reflective film having a refractive index lower than that of the first reflective film; and
an ultraviolet blocking member for blocking ultraviolet rays included in light emitted from a light-emitting portion of the lamp, and for passing visible rays included in light emitted from the light-emitting portion, said ultraviolet blocking member being disposed between the light-emitting portion of the lamp and the reflector.

2. The light source device according to claim 1, wherein said ultraviolet blocking member a tubular ultraviolet blocking member surrounding the light-emitting portion, said tubular ultraviolet blocking member being formed of an ultraviolet blocking glass.

3. The light source device according to claim 1, wherein said ultraviolet blocking member has a tubular ultraviolet blocking member surrounding the light-emitting portion, said tubular ultraviolet blocking member having stacked layers comprising a translucent material layer and an ultraviolet blocking material layer.

4. The light source device according to claim 2, wherein said reflector is formed of a borosilicate glass.

5. The light source device according to claim 3, wherein said reflector is formed of a borosilicate glass.

6. The light source device according to claim 1, wherein said ultraviolet blocking member includes an ultraviolet blocking coating formed over an outside surface of the light-emitting portion.

7. The light source device according to claim 1, wherein said ultraviolet blocking member includes the light-emitting portion formed of an ultraviolet blocking glass.
